(19) United States
(12) Patent Application Publication
(10) Pub. No.: US 2023/0029951 A1
(43) Pub. Date: Feb. 2, 2023

(54) ELECTRONIC DEVICE PERFORMANCE ADJUSTMENT SYSTEM AND METHOD

(71) Applicant: PEGATRON CORPORATION, Taipei City (TW)

(72) Inventors: Kai-Hsuan Wang, Taipei City (TW); Ming-Che Lee, Taipei City (TW); Kai-Hung Wang, Taipei City (TW)

(73) Assignee: PEGATRON CORPORATION, TAIPEI CITY (TW)

(21) Appl. No.: 17/831,292

(22) Filed: Jun. 2, 2022

(30) Foreign Application Priority Data
Jul. 28, 2021 (TW) 110127791

(51) Int. Cl. G06F 1/26; G06F 1/30; G06F 1/3296

(52) U.S. Cl. CPC G06F 1/263; G06F 1/305; G06F 1/3296

(57) ABSTRACT

An electronic device performance adjustment system and an electronic device performance adjustment method are provided. The electronic device performance adjustment system includes an electronic device, a power supply, and a battery. The electronic device is configured to have multiple operation powers. The power supply is coupled to the electronic device. The power supply is configured to provide a supply current to the electronic device. The battery is coupled to the electronic device and the power supply. The battery is configured to provide a battery current to the electronic device. The power supply is configured to charge the battery. The battery has a battery level. The electronic device further includes a controller coupled to the battery. The controller is configured to determine whether to adjust the operation power of the electronic device according to a change in the battery level.

### CROSS-REFERENCE TO RELATED APPLICATION

This application claims the priority benefit of Taiwan application serial no. 110127791, filed on Jul. 28, 2021. The entirety of the above-mentioned patent application is hereby incorporated by reference herein and made a part of this specification.

### BACKGROUND

### Technical Field

The disclosure relates to an electronic device performance adjustment system, and in particular relates to an electronic device performance adjustment system and an electronic device performance adjustment method.

### Description of Related Art

In order to make electronic devices thinner and lighter, the battery and power supply for electronic devices tend to avoid bulky designs. When an electronic device is in operation, the required wattage may be provided by a power supply or a battery. Moreover, when an electronic device operates in a high performance mode, the required wattage may be provided by the power supply and the battery at the same time.

However, if the electronic device continues to operate in the high performance mode, the depletion rate of the battery level of the battery may be higher than the charging rate. As a result, the battery level of the battery continues to drop, which in turn leads to a decrease in the efficiency of the electronic device or a forced shutdown.

### SUMMARY

The disclosure provides an electronic device performance adjustment system and an electronic device performance adjustment method, which dynamically adjust the performance of an electronic device.

The electronic device performance adjustment system according to an embodiment of the disclosure includes an electronic device, a power supply, and a battery. The electronic device is configured to have multiple operation powers, wherein the electronic device operates by one of the operation powers. The power supply is coupled to the electronic device. The power supply is configured to provide a supply current to the electronic device. The battery is coupled to the electronic device and the power supply. The battery is configured to provide a battery current to the electronic device. The power supply is configured to charge the battery. The battery has a battery level. The electronic device further includes a controller coupled to the battery. The controller is configured to detect the battery level. The battery level before a first time has passed is a first battery level, and the battery level after the first time has passed is a second battery level. The controller is configured to determine whether to adjust the operation power operated by the electronic device according to a change in the battery level. When a difference percentage between the first battery level and the second battery level is within a maintenance percentage range, the operation power of the electronic device remains unchanged. The difference percentage is a percentage of a difference between the second battery level and the first battery level relative to a total battery level of the battery.

The electronic device performance adjustment method according to an embodiment of the disclosure is suitable for an electronic device. The electronic device performance adjustment method includes the following. A supply current is provided to the electronic device through a power supply. A battery current is provided to the electronic device through a battery. The battery has a battery level. The power supply is configured to charge the battery. The battery level is detected. The battery level before a first time has passed is a first battery level, and the battery level after the first time has passed is a second battery level. An operation power of the electronic device is adjusted according to a change in the battery level, and when a difference percentage between the first battery level and the second battery level is within a maintenance percentage range, the operation power of the electronic device remains unchanged.

Based on the above, according to the electronic device performance adjustment system and the electronic device performance adjustment method of the disclosure, the electronic device may dynamically adjust a current limit value of the battery according to the change in the battery level. In this way, the electronic device may operate in a stable condition and provide a good user experience.

In order to make the aforementioned features and advantages of the disclosure comprehensible, embodiments accompanied with drawings are described in detail below.

### BRIEF DESCRIPTION OF THE DRAWING

FIG. 1 is a schematic diagram of an electronic device performance adjustment system according to an embodiment of the disclosure.

FIG. 2 is a flowchart of an electronic device performance adjustment method according to an embodiment of the disclosure.

FIG. 3 is a flowchart of an electronic device performance adjustment method according to an embodiment of the disclosure.

FIG. 4 is a flowchart of an electronic device performance adjustment method according to an embodiment of the disclosure.

FIG. 5 is a flowchart of an electronic device performance adjustment method according to an embodiment of the disclosure.

### DETAILED DESCRIPTION OF DISCLOSED EMBODIMENTS

In the following, multiple embodiments of the disclosure will be disclosed with reference to the drawings. For clear description, many practical details will be described together in the following description. However, it should be understood that these practical details should not be used to limit the disclosure. That is, in some embodiments of the disclosure, these practical details are optional. In addition, in order to simplify the drawings, some conventional structures and elements will be omitted or shown by simple illustrations in the drawings.

The term used herein is for the purpose of describing particular embodiments of the disclosure only, and not for the purpose of limiting the disclosure. For example, “a,” “an,” and “the” as used herein do not limit the singular or plural form of the elements. As used herein, “or” means “and/or”. As used herein, the term “and/or” includes any and all combinations of one or more of the associated listed items. It should also be understood that, when used in this specification, the term “including” or “includes” specify a presence of the stated feature, region, subject as a whole, step, operation, element, and/or part, but not excluding the presence or addition of one or more other features, regions, subjects as a whole, steps, operations, elements, parts, and/or a combination thereof. Furthermore, the term “coupled” includes any direct and indirect means of electrical connection.

Unless otherwise defined, all terms (including technical and scientific terms) used herein have the same meaning as that commonly understood by one of ordinary skill in the art to which this disclosure belongs. It should be further understood that terms such as those defined in commonly used dictionaries should be construed as having meanings consistent with their meanings in the context of the related art and the disclosure, and are not to be construed as idealized or excessive formal meaning, unless expressly defined as such herein.

It should be noted that, in the following embodiments, the technical features in several different embodiments may be replaced, reorganized, and mixed to complete other embodiments without departing from the spirit of the disclosure.

Generally speaking, when an electronic device is connected to a power supply, the power required for the operation of the electronic device is provided by the power supply. In addition, when the power required by the electronic device exceeds the capacity of the power supply, the battery, within the capacity range, of the electronic device may make up for the insufficient power. That is, the highest power by which the electronic device may operate is the sum of the power that the power supply and the battery may provide.

However, when the electronic device continues to operate in the high performance mode, the depletion rate of the battery level of the battery may be higher than the charging rate. As a result, the battery level of the battery continues to drop, which in turn leads to a decrease in the performance of the electronic device or a forced shutdown.

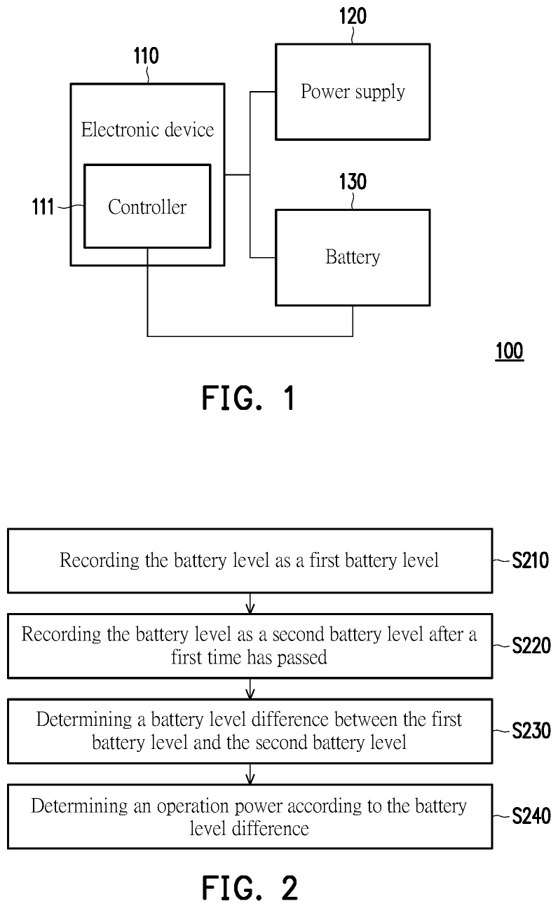

FIG. 1 is a schematic diagram of an electronic device performance adjustment system according to an embodiment of the disclosure. Referring to FIG. 1, an electronic device performance adjustment system 100 may include an electronic device 110, a power supply 120, and a battery 130. The electronic device 110 may be configured to have multiple operation powers. In this embodiment, the multiple operation powers may represent the powers required by the electronic device 110 to operate in multiple different modes. The power supply 120 may be coupled to the electronic device 110. The power supply 120 may be configured to provide a supply current to the electronic device 110. The battery 130 may be coupled to the electronic device 110 and the power supply 120. The battery 130 may be configured to provide a battery current to the electronic device 110. The power supply 120 is configured to charge the battery 130. The battery 130 may have a battery level. The electronic device may further include a controller 111 coupled to the battery 130. The controller 111 may be configured to determine whether to adjust the operation power operated by the electronic device 110 according to a change in the battery level of the battery 130.

In this embodiment, the controller 111 may be configured to detect the battery level of the battery 130 after a certain period of time. Also, the controller 111 may be configured to determine whether to adjust the operation power operated by the electronic device 110 according to a change of the battery level of the battery 130. For example, it is assumed that a current battery level of the battery 130 is a first battery level. Moreover, after the first time has passed, the battery level of the battery 130 is a second battery level. In other words, the battery level of the battery 130 before the first time has passed is the first battery level, and the battery level of the battery 130 after the first time has passed is the second battery level. Then, the controller 111 may adjust the operation power of the electronic device 110 according to the change of the battery level of the battery 130. That is, the controller 111 may adjust the operation power of the electronic device 110 according to the difference between the first battery level and the second battery level. For example, when a difference percentage between the first battery level and the second battery level is within a maintenance percentage range, the operation power remains unchanged. That is, the battery level of the battery 130 does not change significantly, so the operation power remains unchanged. In this embodiment, the difference percentage may be a percentage of a difference between the second battery level and the first battery level relative to a total battery level of the battery 130. Alternatively, when the difference percentage between the first battery level and the second battery level is outside the maintenance percentage range, the controller 111 may be configured to adjust the operation power of the electronic device 110. That is, the battery level of the battery 130 changes significantly, so the controller 111 may adjust the operation power of the electronic device 110 correspondingly.

In this embodiment, multiple current limit values may be configured corresponding to multiple operation powers of the electronic device 110. In other words, the controller 111 may set the current limit value of the battery 130 according to the operation power of the electronic device 110 to ensure that the power supply 120 and the battery 130 provide sufficient current to the electronic device 110. As the operation power changes, the battery current drawn by the electronic device 110 from the battery 130 changes correspondingly. In this way, the electronic device performance adjustment system 100 may dynamically adjust the operation power of the electronic device 110 and the battery current of the battery 130 to ensure that the electronic device 110 operates in a stable condition.

In this embodiment, the electronic device 110 may be, for example, a mobile phone, a tablet computer, a notebook computer, a desktop computer, or other devices capable of performing high performance computing, which is not limited in the disclosure. In this embodiment, the power supply 120 may be, for example, a DC power supply, an AC power supply, or other elements that may provide stable voltage or current, which is not limited in the disclosure. In this embodiment, the battery 130 may be, for example, a lithium battery, a storage battery, a lead-acid battery, a nickel-metal hydride battery, a lithium ion battery, a solar battery, a fuel battery, or other elements having a function of storing electric charges, which is not limited in the disclosure. In this embodiment, the controller 111 may be, for example, a central processing unit (CPU), a processor, a digital signal processor (DSP), a programmable controller, a programmable logic device (PLD), a microprocessor control unit (MCU), a field programmable gate array (FPGA), or other similar devices, or a combination thereof, which is not limited in the disclosure.

Furthermore, in one embodiment, each of the functions of the controller 111 may be implemented as multiple codes. These codes are stored in a memory, and these codes are executed by the controller 111. Alternatively, in one embodiment, each of the functions of the controller 111 may be implemented as one or more circuits. The disclosure does not limit whether each of the functions of the controller 111 is implemented by software or hardware.

FIG. 2 is a flowchart of an electronic device performance adjustment method according to an embodiment of the disclosure. Referring to FIG. 1 and FIG. 2, in step S210, the controller 111 may record the battery level of the battery 130 as a first battery level. In step S220, after a first time has passed, the controller 111 may record the battery level of the battery 130 as a second battery level. In step S230, the controller 111 may determine a battery level difference between the first battery level and the second battery level. In step S240, the controller 111 may determine the operation power of the electronic device 110 according to the battery level difference. In this embodiment, a difference percentage may be defined as a percentage of a difference between the second battery level and the first battery level relative to a total battery level of the battery 130.

In this embodiment, the electronic device 110 may be configured to have multiple operation powers. For example, the multiple operation powers may include a first operation power, a second operation power, and a third operation power, but the number of operation powers of the disclosure is not limited thereto. In addition, the first operation power is greater than the second operation power, and the second operation power is greater than the third operation power. That is, the first operation power is the greatest, and the third operation power is the smallest.

In this embodiment, in step S230 and step S240, when the difference percentage is less than a predetermined reduction percentage range, the controller 111 may be configured to adjust the present operation power to be less than the previous operation power to reduce the operation power of the electronic device 110. For example, the controller 111 may adjust the operation power of the electronic device 110 from the first operation power to the second operation power. That is, when the battery level of the battery 130 continues to drop, the controller 111 may reduce the current drawn by the battery 130. Specifically, the controller 111 may adjust the operation power of the electronic device 110 from the first operation power to the second operation power according to the battery level difference in step S230. In addition, the second operation power is less than the first operation power, to reduce the power required by the electronic device 110 as a whole. Correspondingly, the electronic device 110 adjusts the present current limit value to be less than the previous current limit value, to reduce the current required by the electronic device 110 as a whole. In this way, the battery current provided by the battery 130 to the electronic device 110 is correspondingly reduced, so that the battery level of the battery 130 may be maintained at a certain level or returned to a higher level.

It should be noted that errors may occur when the controller 111 acquires the battery level of the battery 130. Therefore, the reduction percentage range may be set according to the possible error range that occurs in a measurement, to avoid incorrect adjustments of the current limit value and the operation power of the electronic device 110 due to measurement errors. For example, the error range that occurs in a measurement may be from 5% to −2%. Therefore, in this embodiment, a maintenance percentage range may be configured according to the error range, and a predetermined reduction percentage may be configured according to a lower limit of the maintenance percentage range. That is, the maintenance percentage range may be configured to be greater than or equal to −2% to equal to 5%, but the value of the maintenance percentage range of the disclosure is not limited thereto. In addition, the reduction percentage may be correspondingly configured to −2%, but the value of the reduction percentage in the disclosure is not limited thereto. In other words, the controller 111 reduces the operation power and current limit value of the electronic device 110 when the battery 130 is reduced by more than 2% after the first time has passed, to avoid reducing the performance of the electronic device 110 and the battery current provided by the battery 130 due to measurement errors.

In addition, in order to prevent the battery level of the battery 130 from being greatly reduced, the controller 111 may configure a predetermined reduction percentage range according to the reduction percentage. In addition, when the battery level reduced of the battery 130 after the first time has passed is less than the reduction percentage range, the controller 111 may reduce the operation power of the electronic device 110 to a greater extent. In this embodiment, the reduction percentage range may be configured to be less than −2% to equal to −10%, but the disclosure is not limited thereto. In other words, when the battery level of the battery 130 is reduced by more than 10% after the first time has passed, the controller 111 may reduce the operation power of the electronic device 110 to prevent the battery 130 from losing battery level to a greater extent. For example, when the battery level of the battery 130 is reduced by more than 10% after the first time has passed, the controller 111 may directly adjust the operation power of the electronic device 110 from the first operation power to the third operation power.

In this embodiment, in step S230 and step S240, when the difference percentage is within the maintenance percentage range, the controller 111 may be configured to keep the current limit value and operation power of the electronic device 110 unchanged. In other words, the battery level of the battery 130 does not change significantly after the first time has passed. That is, after the first time has passed, if the change in the battery level of the battery 130 is within the maintenance percentage range, the controller 111 may maintain the current limit value and the operation power of the electronic device 110. In this way, the electronic device performance adjustment system 100 may avoid being affected by the measurement errors of the battery level, thereby providing a good user experience.

In addition, when the battery level of the battery 130 is reduced, the corresponding battery voltage is also reduced. In order to prolong the lifespan of the battery 130, the battery 130 may be configured with a rated voltage according to the specifications to ensure that the battery 130 may operate normally. In this embodiment, in step S220, when the second battery level of the battery 130 recorded by the controller 111 after the first time has passed is less than a threshold battery level, the controller 111 may be configured to reduce the operation power of the electric device 110 to a lower operation power, and only draw current from the power supply 120. In other words, the battery current of the battery 130 is adjusted to zero to avoid excessively discharging the battery 130, which reduces the lifespan. That is, the threshold battery level corresponds to the rated voltage of the battery 130. In one embodiment, the threshold battery level may be configured to 5%, corresponding to the rated voltage, but the value of the rated voltage of the disclosure is not limited thereto. In another embodiment, since the measurement error of the battery 130 increases when the battery 130 is at a low battery level, the threshold battery level may be configured to 30%, according to the rated voltage and a safety factor, but the value of the threshold voltage of the disclosure is not limited thereto.

Furthermore, in this embodiment, in step S230 and step S240, when the difference percentage is greater than the maintenance percentage, the controller 111 may be configured to adjust the present operation power to be greater than the previous operation power. Correspondingly, the present current limit value may be adjusted to be greater than the previous current limit value. That is, the battery 130 is in a state of being stably charged, so the controller 111 may increase the operation power of the electronic device 110. For example, when the battery 130 increases by more than 2% after the first time has passed, the controller 111 increases the operation power and the current limit value of the electronic device 110 to avoid increasing the battery current provided by the battery 130 due to measurement errors.

In this embodiment, the controller 111 may set the performance of the electronic device 110 according to a new operation power, to ensure that the power supply 120 and the battery 130 may provide sufficient current to the electronic device 110. Specifically, the controller 111 may increase or decrease the element power of one or more elements of the electronic device 110 to increase or decrease the operation power of the electronic device 110.

In this embodiment, the electronic device 110 may include multiple processors and elements such as a central processing unit (CPU), a graphic processing unit (GPU), a Wi-Fi module, a Bluetooth module, etc. In this embodiment, the controller 111 may detect the processor or element with the highest power in the electronic device 110 at present. Then, the controller 111 may reduce the processor power of the processor or the element power of the elements to reduce the operation power of the electronic device 110 as a whole, thereby reducing the maximum current required by the electronic device 110. In this embodiment, the multiple operation powers may correspond to multiple processor powers. The controller 111 may configure the multiple current limit values corresponding to the multiple processor powers according to the power supply specifications of the power supply 120 and the battery specifications of the battery 130. In this embodiment, the controller 111 may reduce the processor frequency of the CPU or the GPU to reduce the operation power of the electronic device 110, but the disclosure is not limited thereto. Alternatively, the controller 111 may maintain the element power of the element and reduce the element power of one or more other elements to provide a good user experience. In this embodiment, in order to provide a good user experience, the controller 111 may selectively turn off secondary elements, unnecessary elements, or reduce the power of elements that have less impact on the user experience, but the disclosure is not limited thereto. In other words, the controller 111 may turn on or off the multiple elements to adjust the operation power according to the element powers of each of the multiple elements. Alternatively, the controller 111 may reduce the element power of one or more other elements in a specific order according to user configurations.

Similarly, when the operation power of the electronic device 110 may be increased, the controller 111 may control one or more elements of the electronic device 110 in a manner similar to that described above. That is, the controller 111 may set the performance of the electronic device 110 according to the element powers of each of the multiple elements of the electronic device 110 or the user configurations, to ensure that the power supply 120 and the battery 130 may provide sufficient current to the electronic device 110, and to ensure that the electronic device 110 may perform effectively.

It should be noted that, in this embodiment, step S210 to step S240 may be activated through user configurations to inspect the battery level of the battery 130 and make corresponding adjustments, but the disclosure is not limited thereto. In another embodiment, step S210 to step S240 may be activated through predetermined conditions. For example, these conditions may include, but are not limited to: the electronic device 110 executes an application program requiring higher computing power, the controller 111 detects that a battery level of the battery 130 is lower than a configured threshold value, the controller 111 detects that a health value of the battery 130 is below a configured threshold value, or the electronic device 110 continues to be used for more than a certain length of time. Through the above-mentioned configurations, the controller 111 may dynamically adjust the current limit value and the operation power of the electronic device 110 according to the change of the battery level of the battery 130. In this way, the battery level of the battery 130 may be maintained at a certain level to ensure that the electronic device 110 operates in a stable condition.

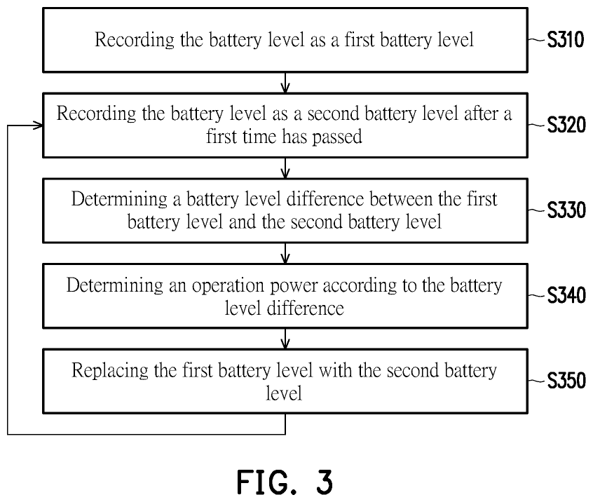

FIG. 3 is a flowchart of a power supply method according to an embodiment of the disclosure. Referring to FIG. 1 to FIG. 3, step S310 to step S340 in FIG. 3 are similar to step S210 to step S240 in FIG. 2, and are not repeated herein. The difference between FIG. 2 and FIG. 3 is that step S210 to step S240 in FIG. 2 are activated through user configurations or predetermined conditions, while step S320 to step S350 in FIG. 3 are executed at specific time intervals.

Specifically, in step S350, the controller 111 may replace the first battery level with the second battery level, and step S320 and subsequent steps are repeated. That is, the controller 111 may detect the battery level of the battery 130 every time the first time has passed, to keep the battery level of the battery 130 at a certain level. In this embodiment, the first time may be, for example, 15 minutes to 1 hour, but the length of the first time in the disclosure is not limited thereto. For example, the controller 111 may detect the battery level of the battery 130 every 15 minutes to ensure that the battery level of the battery 130 is within an ideal range. In this way, the electronic device 110 may operate in a stable condition.

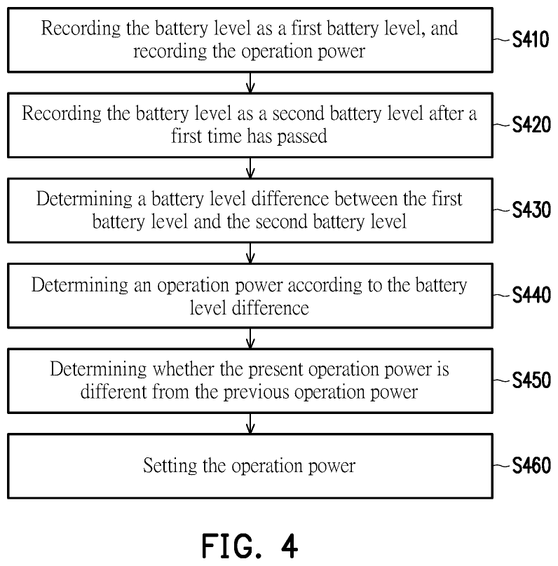

FIG. 4 is a flowchart of a power supply method according to an embodiment of the disclosure. Referring to FIG. 1 to FIG. 4, step S410 to step S440 in FIG. 3 are similar to steps S210 to S240 in FIG. 2, and are not repeated herein. The difference between FIG. 2 and FIG. 4 is that, in step S210 and step S240 in FIG. 2, the operation power of the electronic device 110 is determined by recording the battery level difference of the battery 130 after the first time has passed, while in step S410 and step S440 in FIG. 4, the operation power of the electronic device 110 is further recorded to be provided to the subsequent step S450 and step S460.

Specifically, in step S410, the controller 111 may record the battery level of the battery 130 as the first battery level, and the controller 111 may record the present operation power of the electronic device 110 from multiple operation powers. In step S440, the controller 111 may determine the operation power of the electronic device 110 after the first time has passed from the multiple operation powers according to the battery level difference of the first battery level and the second battery level.

In this embodiment, the electronic device 110 may include multiple current limit values corresponding to different operation powers. For example, the multiple operation powers may include a first operation power, a second operation power, and a third operation power, but the number of operation powers of the disclosure is not limited thereto. Wherein, the first operation power is greater than the second operation power, and the second operation power is greater than the third operation power. Correspondingly, the multiple current limit values may include a first current limit value, a second current limit value, and a third current limit value, but the number of current limit values in the disclosure is not limited thereto. Wherein, the first current limit value is greater than the second current limit value, and the second current limit value is greater than the third current limit value. In one embodiment, the controller 111 may configure the multiple operation powers according to the power supply specifications of the power supply 120 and the battery specifications of the battery 130. The first operation power may correspond to the highest operation power when the electronic device 110 operates at the highest performance. In this embodiment, the first current limit value may be configured as the sum of the maximum supply current that the power supply 120 may provide and the maximum battery current that the battery 130 may provide, but the disclosure is not limited thereto. The second operation power may be configured as the second highest operation power of the electronic device 110, for example, 80% of the highest operation power, but the disclosure is not limited thereto. Correspondingly, the second current limit value may correspond to the second highest current limit value of the electronic device 110, for example, 80% of the highest current, but the disclosure is not limited thereto. The third operation power may be configured as the third highest operation power of the electronic device 110, for example, 60% of the highest operation power, but the disclosure is not limited thereto. Correspondingly, the third current limit value may correspond to the third highest current limit value of the electronic device 110, for example, 60% of the highest current, but the disclosure is not limited thereto. That is, the first power, the second power, and the third power respectively correspond to the three operation powers of the electronic devices 110 from large to small. Correspondingly, the first current limit value, the second current limit value, and the third current limit value respectively correspond to the three current limit values of the electronic device 110 from large to small.

Returning to step S410, the controller 111 may record the present battery level of the battery 130 as the first battery level, and the controller 111 may record the present operation power of the electronic device 110 from multiple operation powers. In this embodiment, the present operation power may be one of the first operation power, the second operation power, or the third operation power. For example, the current battery level of the battery 130 is 90%, and the present operation power is the first operation power. Therefore, the controller 111 may record the first battery level as 90%, and the controller 111 may record the present operation power as the first operation power, but the disclosure is not limited thereto.

In step S420, the controller 111 may record the battery level of the battery 130 as the second battery level after the first time has passed. In this embodiment, the second battery level of the battery 130 may be 85%, but the disclosure is not limited thereto.

In step S430, the controller 111 may determine a battery level difference between the first battery level and the second battery level. In this embodiment, since the first battery level of the battery 130 is 90% and the second battery level is 85%, the battery level difference of the battery 130 is 5%. Alternatively, with reference to the aforementioned definition, the difference percentage is −5%.

In step S440, the controller 111 may determine the second current limit value according to the battery level difference. In other words, the controller 111 may determine the second current limit value according to the difference percentage. In this embodiment, the difference percentage of the battery 130 is −5%. That is, the difference percentage is less than the maintenance percentage range (5% to −2%) and within the reduction percentage range (−2% to −10%), so the controller 111 may determine the present operation power as the second operation power corresponding to the second highest operation power of the electronic device 110.

It should be noted that the operation power may include the first operation power, the second operation power, and the third operation power, and the reduction percentage range may configure multiple reduction percentage ranges according to the difference percentage, but the number of operation power or predetermined reduction percentages of the disclosure is not limited thereto. In this embodiment, the controller 111 may configure a reduction percentage range, and the reduction percentage range is less than −2% to equal to −10%. When the difference percentage is within the reduction percentage range (representing a slight reduction in the battery level of the battery 130), the controller 111 may lower the present operation power by one step. For example, the operation power is reduced from a first operation power to a second operation power. That is, when the difference percentage is less than the maintenance percentage range and is within the reduction percentage range, the controller 111 may be configured to adjust the electronic device 110 from the first operation power to the second operation power. Moreover, when the difference percentage is less than the reduction percentage range (representing that the battery level of the battery 130 is reduced by a greater extent), the controller 111 may lower the present current limit value by two steps. For example, the operation power is reduced from a first operation power to a third operation power. Alternatively, when the difference percentage is less than the reduction percentage range, the controller 111 may directly adjust the present operation power to the lowest operation power to avoid excessive depletion of the battery 130. In one embodiment, the second battery level may be 75%. That is, the difference percentage is −15%, which is less than the reduction percentage range (−2% to −10%). Therefore, the controller 111 may determine the present operation power as the third operation power corresponding to the third highest operation power of the electronic device 110. In another embodiment, the second battery level may be 89%. That is, the power difference of the battery 130 is −1%, and the controller 111 may determine the present operation power to be maintained at the first operation power. It should be noted that the above-mentioned values of the battery level and the reduction percentage range are only exemplary examples, and the disclosure does not limit the numerical value of the battery level and the reduction percentage range.

Moreover, similar to the reduction percentage range, the controller configures an elevation percentage range according to the difference percentage. For example, the elevation percentage range may be greater than 5% to equal to 15%. When the difference percentage is within the elevation percentage range (representing a slight increase in the battery level of the battery 130), the controller 111 may raise the present operation power by one step. For example, the operation power is elevated from a third operation power to a second operation power. Alternatively, the controller 111 may directly adjust the present operation power to the highest operation power, to improve the performance of the electronic device 110. Moreover, when the difference percentage is greater than the elevation percentage range (representing that the battery level of the battery 130 is increased by a greater extent), the controller 111 may raise the present current limit value by two steps. For example, the operation power is elevated from a third operation power to a first operation power. Alternatively, the controller 111 may directly adjust the present operation power to the highest operation power, to improve the performance of the electronic device 110.

That is, when the second battery level is lower than the first battery level, the controller 111 may determine a suitable operation power as the present operation power according to the battery level difference, so as to slow down the reduction rate of the battery level of the battery 130. Alternatively, when the second battery level is higher than the first battery level, the controller 111 may determine a suitable operation power as the present operation power according to the battery level difference, to increase the performance of the electronic device 110. Moreover, similar to the configurations in FIG. 2, the controller 111 may add range parameters such as the maintenance percentage range, the reduction percentage range, and the elevation percentage, to reduce the occurrence of misjudgment.

In step S450, the controller 111 may determine whether the present operation power is different from the previous operation power. In step S460, when the present operation power is different from the previous operation power, the controller 111 may set the present operation power according to the determined operation power. Moreover, the controller 111 may set the current limit value of the electronic device 110 according to the present operation power, to ensure that the power supply 120 and the battery 130 may provide sufficient current to the electronic device 110, and to ensure that the electronic device 110 may perform effectively. In step S460, when the present operation power is the same as the previous operation power, the controller 111 may set the operation power according to the determined (previous) operation power. Moreover, since the operation power has not changed, the controller 111 may maintain the settings of the electronic device 110. In this way, the power supply system 100 may dynamically adjust the current limit value and operation power of the electronic device 110 according to the battery level of the battery 130 to provide a good practical experience.

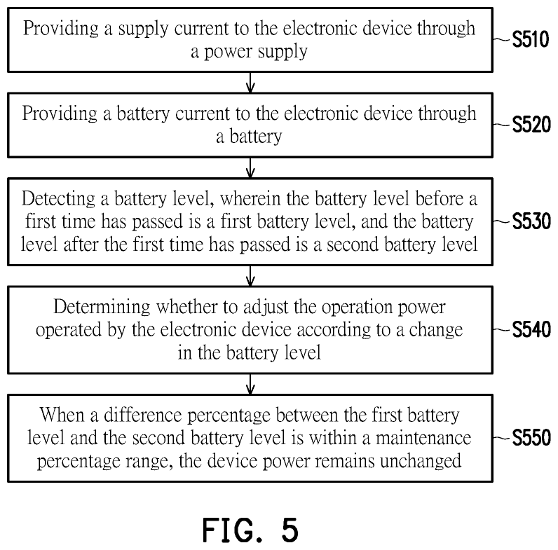

FIG. 5 is a flowchart of a power supply method according to an embodiment of the disclosure. Referring to FIG. 1 and FIG. 5, the power supply method of the disclosure may be suitable for an electronic device 110 configured with multiple operation powers. In step S510, a supply current may be provided to the electronic device 110 through the power supply 120. In step S520, the battery current may be provided to the electronic device 110 through the battery 130. The battery 130 includes a battery level. The power supply 120 is configured to charge the battery 130. In step S530, the controller 111 may detect the battery level. Wherein, the battery level before a first time has passed is a first battery level, and the battery level after the first time has passed is a second battery level. In step S540, the controller 111 may determine whether to adjust the operation power operated by the electric device 110 according to a change in the battery level of the battery 130. In step S550, when a difference percentage between the first battery level and the second battery level is within a maintenance percentage range, the current limit value remains unchanged. Wherein, the difference percentage range is a percentage of a difference between the second battery level and the first battery level relative to a total battery level of the battery 130.

To sum up, through the above-mentioned design of the power supply system and the power supply method, the electronic device dynamically adjusts the operation power and current limit value of the electronic device under different operating conditions, to draw a suitable battery current from the battery. In this way, the electronic device may perform effectively, and various problems caused by excessive reduction of the battery level of the battery may be avoided.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. An electronic device performance adjustment system, comprising:
an electronic device, configured to have a plurality of operation powers, wherein the electronic device operates by one of the operation powers;
a power supply, coupled to the electronic device and configured to provide a supply current to the electronic device; and
a battery, coupled to the electronic device and the power supply and configured to provide a battery current to the electronic device, wherein the power supply is configured to charge the battery, and the battery has a battery level,
wherein the electronic device further comprises a controller coupled to the battery and configured to detect the battery level, wherein the battery level before a first time has passed is a first battery level, and the battery level after the first time has passed is a second battery level,
the controller is configured to determine whether to adjust the operation power operated by the electronic device according to a change in the battery level,
when a difference percentage between the first battery level and the second battery level is within a maintenance percentage range, the operation power remains unchanged, wherein the difference percentage is a percentage of a difference between the second battery level and the first battery level relative to a total battery level of the battery.

2. The electronic device performance adjustment system according to claim 1, wherein the operation powers comprise a first operation power, a second operation power, and a third operation power, in which the first operation power is greater than the second operation power, and the second operation power is greater than the third operation power.

3. The electronic device performance adjustment system according to claim 2, wherein when the difference percentage is greater than the maintenance percentage range, the controller determines whether the operation power is the first operation power,
the operation power is maintained if the operation power is the first operation power, and
the operation power is adjusted to the first operation power if the operation power is not the first operation power.

4. The electronic device performance adjustment system according to claim 3, wherein when the difference percentage is less than the maintenance percentage range and within a reduction percentage range, the controller determines whether the operation power is the second operation power,
the operation power is maintained if the operation power is the second operation power, and
the operation power is adjusted to the second operation power if the operation power is not the second operation power.

5. The electronic device performance adjustment system according to claim 4, wherein when the difference percentage is less than the reduction percentage range, the controller determines whether the operation power is the third operation power,
the operation power is maintained if the operation power is the third operation power, and
the operation power is adjusted to the third operation power if the operation power is not the third operation power.

6. The electronic device performance adjustment system according to claim 5, wherein the maintenance percentage range is greater than or equal to −2% to equal to 5%, and the reduction percentage range is less than −2% to equal to −10%.

7. The electronic device performance adjustment system according to claim 1, wherein when the second battery level is less than a threshold battery level, the controller adjusts the battery current to zero.

8. The electronic device performance adjustment system according to claim 5, wherein the threshold battery level corresponds to a rated voltage of the battery.

9. The electronic device performance adjustment system according to claim 1, wherein the electronic device further comprises a processor, in which the operation powers correspond to a plurality of processor powers, and the controller configures a plurality of current limit values corresponding to the processor powers according to power supply specifications of the power supply and battery specifications of the battery.

10. The electronic device performance adjustment system according to claim 2, wherein the electronic device comprises a plurality of elements, and the controller turns on or off the elements to adjust the operation power according to an element power of each of the elements.

11. An electronic device performance adjustment method, adapted for an electronic device configured to have a plurality of operation powers, the electronic device performance adjustment method comprising:
providing a supply current to the electronic device through a power supply;
providing a battery current to the electronic device through a battery, wherein the battery has a battery level, and the power supply is configured to charge the battery;
detecting the battery level, wherein the battery level before a first time has passed is a first battery level, and the battery level after the first time has passed is a second battery level;
determining whether to adjust the operation power according to a change in the battery level; and
maintaining the operation power when a difference percentage between the first battery level and the second battery level is within a maintenance percentage range, wherein the difference percentage is a percentage of a difference between the second battery level and the first battery level relative to a total battery level of the battery.

12. The electronic device performance adjustment method according to claim 11, wherein the operation powers comprise a first operation power, a second operation power, and a third operation power, in which the first operation power is greater than the second operation power, and the second operation power is greater than the third operation power.

13. The electronic device performance adjustment method according to claim 12, further comprising:
determining whether the operation power is the first operation power when the difference percentage is greater than the maintenance percentage range,
maintaining the operation power if the operation power is the first operation power, and
adjusting the operation power to the first operation power if the operation power is not the first operation power.

14. The electronic device performance adjustment method according to claim 12, further comprising:
determining whether the operation power is the second operation power when the difference percentage is less than the maintenance percentage range and within a reduction percentage range,
maintaining the operation power if the operation power is the second operation power, and
adjusting the operation power to the second operation power if the operation power is not the second operation power.

15. The electronic device performance adjustment method according to claim 14, further comprising:
determining whether the operation power is the third operation power when the difference percentage is less than the reduction percentage range,
maintaining the operation power if the operation power is the third operation power, and
adjusting the operation power to the third operation power if the operation power is not the third operation power.

16. The electronic device performance adjustment method according to claim 15, wherein the maintenance percentage range is greater than or equal to −2% to equal to 5%, and the reduction percentage range is less than −2% to equal to −10%.

17. The electronic device performance adjustment method according to claim 11, further comprising:
adjusting the battery current to zero when the second battery level is less than a threshold battery level.

18. The electronic device performance adjustment method according to claim 15, wherein the threshold battery level corresponds to a rated voltage of the battery.

19. The electronic device performance adjustment method according to claim 11, wherein the electronic device further comprises a processor, in which the operation powers correspond to a plurality of processor powers, the electronic device performance adjustment method further comprising:
configuring a plurality of current limit values corresponding to the processor powers according to power supply specifications of the power supply and battery specifications of the battery.

20. The electronic device performance adjustment method according to claim 12, further comprising:
turning on or off a plurality of elements of the electronic device to adjust the operation power according to an element power of each of the elements.
